(19) United States
(12) Patent Application Publication
(10) Pub. No.: US 2023/0006221 A1
(43) Pub. Date: Jan. 5, 2023

(54) PRESSURIZED AIR SUPPLY SYSTEM AND METHOD FOR STARTING PRESSURIZED AIR SUPPLY SYSTEM

(71) Applicant: MITSUBISHI HEAVY INDUSTRIES, LTD., Tokyo (JP)

(72) Inventors: Yasushi Iwai, Tokyo (JP); Ryutaro Mori, Tokyo (JP); Hiroyuki Ozawa, Kanagawa (JP); Yoshiki Kato, Kanagawa (JP)

(73) Assignee: MITSUBISHI HEAVY INDUSTRIES, LTD., Tokyo (JP)

(21) Appl. No.: 17/781,562

(22) PCT Filed: Dec. 18, 2020
(86) PCT No.: PCT/JP2020/047414

§ 371 Date: Jun. 1, 2022

(30) Foreign Application Priority Data
Dec. 18, 2019 (JP) 2019-228112
Nov. 4, 2020 (JP) 2020-184727

(51) Int. Cl. H01M 8/04111; F02C 6/08; F02C 6/12; H01M 8/0432; H01M 8/0438

(52) U.S. Cl. CPC H01M 8/04111; F02C 6/08; F02C 6/12; H01M 8/0432; H01M 8/0438

(57) ABSTRACT

A pressurized air supply system supplies, to a pressurization object device, flowing air that includes at least one of compressed air, which is generated by compressing air supplied from an air supply source, or discharged air from a turbocharger compressor forming a turbocharger. The compressor is controlled such that a saturated steam temperature of the flowing air supplied from the air supply source to the pressurization object device is lower than a temperature in the pressurization object device, at startup.

### TECHNICAL FIELD

The present disclosure relates to a pressurized air supply system for supplying pressurized air and a method for starting the pressurized air supply system.

### BACKGROUND

There is a device that operates with pressurized air generated by a compressor or the like (hereinafter, appropriately referred to as a “pressurization object device”). The pressurized air necessary for the operation is supplied to the pressurization object device by a pressurized air supply system.

As a kind of the pressurization object device of this kind, for example, there is a Solid Oxide Fuel Cell (SOFC) as a fuel cell. The SOFC is known as a versatile and highly efficient fuel cell. The SOFC is expected as a combined cycle power generation system that can achieve high-efficiency power generation by being combined with a turbocharger. For example, Patent Document 1 and Patent Document 2 each disclose an example of a combined cycle power generation system that includes the SOFC, and a turbocharger for combusting an exhaust fuel gas or exhaust air exhausted from the SOFC.

Since an operating temperature of the SOFC is set high in order to increase ion conductivity, in such combined power generation system, it is possible to use air, which has been increased in temperature and pressure by a compressor of the turbocharger, as air (oxidizer) to be supplied to an air electrode side (that is, the compressor or the like functions as a pressurized air supply system). However, since an internal temperature of the SOFC is low at startup, if the compressed air, which has been increased in temperature and pressure, is supplied from the compressor, a condensable gas such as water vapor contained in the compressed air may become a drain and may condense in the SOFC, which causes deterioration in the SOFC.

In Patent Document 3, when air, which has been increased in temperature and pressure by a compressor, is supplied to a fuel cell, a condensable gas contained in air is recovered as a drain in advance by a condenser. Thereby, it is disclosed that the air after the condensable gas is recovered is supplied to an air electrode of the fuel cell, making it possible to prevent the generation of the drain in the fuel cell.

### CITATION LIST

### Patent Literature

### Patent Document 1: JP2018-6004A

### Patent Document 2: JP2018-6003A

### Patent Document 3: JP6081167B

### SUMMARY

### Technical Problem

Patent Document 3 described above requires a condenser for recovering the condensable gas as the drain from the air which has been increased in temperature and pressure by the compressor. Consequently, a system configuration becomes complicated, and a cost increases.

At least one embodiment of the present invention was made in view of the above, and an object of the present invention is to provide a pressurized air supply system capable of preventing generation of a drain at startup and a method for staring the pressurized air supply system, while suppressing complication of a configuration in a pressurization object device.

### Solution to Problem

In order to solve the above-described problem, a pressurized air supply system according to an aspect of the present disclosure includes a turbocharger including a turbine and a turbocharger compressor, a recuperator for performing heat exchange between discharged air from the turbocharger compressor and an exhaust gas exhausted from the turbine, a compressor capable of compressing air supplied from an air supply source, a pressurization object device that is supplied with flowing air which includes at least one of the discharged air or compressed air generated by the compressor, the pressurization object device being configured to exhaust the flowing air to the turbine, and a heater configured to heat the flowing air supplied to the pressurization object device. The compressor is controlled such that a saturated steam temperature of the flowing air supplied from the air supply source to the pressurization object device is lower than a temperature in the pressurization object device, at startup.

In order to solve the above-described problem, a method for starting a pressurized air supply system according to an aspect of the present disclosure is a method for starting a pressurized air supply system that includes a turbocharger including a turbine and a turbocharger compressor, a recuperator for performing heat exchange between discharged air from the compressor and an exhaust gas exhausted from the turbine, a compressor capable of compressing air supplied from an air supply source, a pressurization object device that is supplied with flowing air which includes at least one of the discharged air or compressed air generated by the compressor, the pressurization object device being configured to exhaust the flowing air to the turbine, and a heater configured to heat the flowing air supplied to the pressurization object device. The compressor is controlled such that a saturated steam temperature of the flowing air supplied from the air supply source to the pressurization object device is lower than a temperature in the pressurization object device, at startup.

### Advantageous Effects

According to an aspect of the present disclosure, it is to provide a pressurized air supply system capable of preventing generation of a drain at startup and a method for staring the pressurized air supply system, while suppressing complication of a configuration in a pressurization object device.

### BRIEF DESCRIPTION OF DRAWINGS

FIG. 1 is an overall configuration diagram of a pressurized air supply system according to the first embodiment.

FIG. 2 is a flowchart showing steps of a method for starting the pressurized air supply system of FIG. 1.

FIG. 3A is an overall configuration diagram showing an operating state of the pressurized air supply system corresponding to the main steps of FIG. 2.

FIG. 3B is an overall configuration diagram showing the operating state of the pressurized air supply system corresponding to the main steps of FIG. 2.

FIG. 3C is an overall configuration diagram showing the operating state of the pressurized air supply system corresponding to the main steps of FIG. 2.

FIG. 3D is an overall configuration diagram showing the operating state of the pressurized air supply system corresponding to the main steps of FIG. 2.

FIG. 4 is a modified example of FIG. 1.

FIG. 5 is another modified example of FIG. 1.

FIG. 6 is an overall configuration diagram of a pressurized air supply system according to the second embodiment.

FIG. 7 is a flowchart showing steps of the method for starting the pressurized air supply system of FIG. 6.

FIG. 8A is an overall configuration diagram showing the operating state of the pressurized air supply system corresponding to the main steps of FIG. 7.

FIG. 8B is an overall configuration diagram showing the operating state of the pressurized air supply system corresponding to the main steps of FIG. 7.

FIG. 8C is an overall configuration diagram showing the operating state of the pressurized air supply system corresponding to the main steps of FIG. 7.

FIG. 9 is a modified example of FIG. 6.

FIG. 10 is another modified example of FIG. 6.

### DETAILED DESCRIPTION

Embodiments of the present invention will now be described in detail with reference to the accompanying drawings. However, the scope of the present invention is not limited to the following embodiments. It is intended that dimensions, materials, shapes, relative positions and the like of components described in the embodiments shall be interpreted as illustrative only and not intended to limit the scope of the present invention.

### First Embodiment

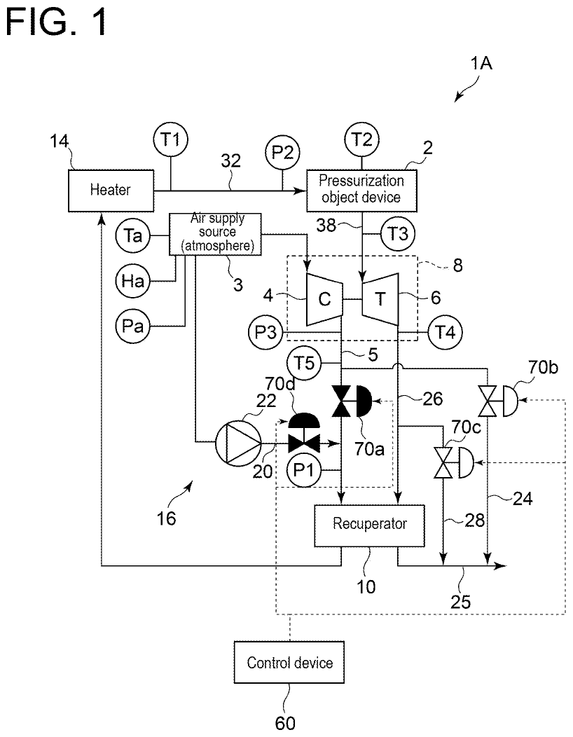

FIG. 1 is an overall configuration diagram of a pressurized air supply system 1A according to the first embodiment. The pressurized air supply system 1A is a system for supplying pressurized air to a pressurization object device 2. The purpose of supplying the pressurized air to the pressurization object device 2 may be startup of the pressurization object device 2 or may be another purpose. Further, the pressurization object device 2 may be any device that requires pressurized air, and is, for example, a Solid Oxide Fuel Cell (SOFC) that requires pressurized air for operation. In this case, the pressurized air supply system 1A is configured to supply pressurized air to an air electrode of the air electrode and a fuel electrode of the SOFC.

The pressurized air supply system 1A includes a turbocharger 8 with a turbocharger compressor 4 and a turbine 6, a recuperator 10 for performing heat exchange between discharged air discharged from the turbocharger compressor 4 via a discharged air line 5 and an exhaust gas exhausted from the turbine 6, and a heater 14 for heating the air that has passed through the recuperator 10 from the discharged air line 5. The turbocharger compressor 4 compresses air taken in from an air supply source 3 (atmosphere) and discharges the compressed air to the discharged air line 5 on the downstream side. The air discharged to the discharged air line 5 passes through the recuperator 10, and then is supplied to the heater 14. The heater 14 is configured to heat the flowing air supplied to the pressurization object device 2. The air heated by the heater 14 is supplied to the pressurization object device 2 through a heated air line 32. The air used in the pressurization object device 2 is exhausted to the turbine 6.

An air supply system 16 includes a compressor 22 for pumping the air taken in from the air supply source 3, and an air line 20 communicating with the discharged air line 5. The pressurized air supply system 1A mainly supplies the pressurized air discharged from the turbocharger compressor 4 of the turbocharger 8 to the pressurization object device 2. For example, at the initial stage of startup, since the flow rate of the exhaust gas flowing through the turbine 6 is low and a gas temperature is also low, the supply of pressurized air by the turbocharger compressor 4 is insufficient. Therefore, the air supply system 16 is configured to supply an appropriate amount of flowing air to the system by, for example, operating in place of the turbocharger compressor 4 at the initial stage of startup.

Further, the discharged air line 5 includes a first bypass line 24 which bypasses the recuperator 10 and communicates with an exhaust gas exhaust line 25 of the recuperator 10 continuing to the outside (the exhaust gas exhaust line 25 may be provided with an exhaust heat recovery device or the like). Further, an exhaust gas line 26, through which the exhaust gas exhausted from the turbine 6 flows, includes a second bypass line 28 which bypasses the recuperator 10 and communicates with the exhaust gas exhaust line 25 of the recuperator 10 continuing to the outside.

The pressurized air supply system 1A includes at least one flow control valve for controlling the flow rate of the air flowing through each part. As such flow control valve, the pressurized air supply system 1A includes a first flow control valve 70a disposed on the discharged air line 5, a second flow control valve 70b disposed on the first bypass line 24, a third flow control valve 70c disposed on the second bypass line 28, and a fourth flow control valve 70d disposed on the air line 20. The first flow control valve 70a is configured such that the flow rate of the air flowing through the discharged air line 5 becomes variable by adjusting the opening degree of the first flow control valve 70a. The second flow control valve 70b is configured such that the flow rate of the air flowing through the first bypass line 24 becomes variable by adjusting the opening degree of the second flow control valve 70b. The third flow control valve 70c is configured such that the flow rate of the air flowing through the second bypass line 28 becomes variable by adjusting the opening degree of the third flow control valve 70c. The fourth flow control valve 70d is configured such that the flow rate of the air flowing through the air line 20 becomes variable by adjusting the opening degree of the fourth flow control valve 70d.

Although the details will be described later, in the pressurized air supply system 1A, in an initial state such as when stopped, as shown in FIG. 1, the first flow control valve 70a and the fourth flow control valve 70d are set in a fully closed state, and the second flow control valve 70b and the third flow control valve 70c are set in a fully open state.

The pressurized air supply system 1A includes a temperature measuring device for measuring the temperature of each part. Describing specifically, the heated air line 32, which causes the heater 14 to communicate with the pressurization object device 2, includes a first temperature measuring device T1 for measuring the temperature of the air flowing through the heated air line 32. The pressurization object device 2 includes a second temperature measuring device T2 for measuring the temperature of the pressurization object device 2. The temperature measured by the second temperature measuring device T2 is, for example, a temperature of a portion of the pressurization object device 2 where the temperature increase is expected to be the slowest or a portion of the pressurization object device 2 where the generation of the drain should be prevented. Further, a used air line 38, which causes the pressurization object device 2 to communicate with the turbine 6, includes a third temperature measuring device T3 for measuring the temperature of the gas flowing through the used air line 38. Further, the exhaust gas line 26 includes a fourth temperature measuring device T4 for measuring the temperature of the air (exhaust gas) flowing through the exhaust gas line 26. Further, the discharged air line 5 includes a fifth temperature measuring device T5 for measuring the temperature of the air flowing through the discharged air line 5. Further, an atmospheric temperature measuring device Ta measures an atmospheric temperature (outside air temperature) of the air supply source 3. The first temperature measuring device T1, the second temperature measuring device T2, the third temperature measuring device T3, the fourth temperature measuring device T4, the fifth temperature measuring device T5, and the atmospheric temperature measuring device Ta are each constituted by a temperature sensor such as a thermocouple, and can output a measured value to the outside as an electrical signal.

The pressurized air supply system 1A also includes a pressure measuring device for measuring the pressure of each part. Describing specifically, on the downstream side of a junction of the discharged air line 5 with the air line 20, provided is a first pressure measuring device P1 for measuring the pressure of the discharged air line 5 on the downstream side of the first flow control valve 70a. The heated air line 32 includes a second pressure measuring device P2 for measuring the pressure of the heated air line 32. On the upstream side of the first flow control valve 70a on the discharged air line 5, provided is a third pressure measuring device P3 for measuring the pressure of the discharged air from the turbocharger compressor 4. Further, an atmospheric pressure measuring device Pa measures an atmospheric pressure (outside atmospheric pressure) of the air supply source 3. The first pressure measuring device P1, the second pressure measuring device P2, the third pressure measuring device P3, and the atmospheric pressure measuring device Pa are each constituted by, for example, a pressure sensor, and is configured to output a measured value to the outside as an electrical signal.

The pressurized air supply system 1A also includes an atmospheric air relative humidity measuring device Ha for measuring the atmospheric air relative humidity of external air of the air supply source 3. The atmospheric air relative humidity measuring device Ha is constituted by, for example, a humidity sensor, and is configured to output a measured value to the outside as an electrical signal.

A control device 60 is a control unit for controlling each constituent element of the pressurized air supply system 1A, and has a hardware configuration constituted by an electronic computation device such as a computer. The electronic computation device is configured to function as a control unit of the pressurized air supply system 1A by installing a program for carrying out the operation of the pressurized air supply system 1A (including a method for starting the pressurized air supply system 1A) in the electronic computation device.

The control device 60 is electrically connected to each of the temperature measuring devices, the pressure measuring devices, and the humidity measuring device described above, and controls each constituent element of the pressurized air supply system 1A based on the measurement signal from each measuring device. FIG. 1 representatively shows signal lines for transmitting and receiving control signals to the first flow control valve 70a, the second flow control valve 70b, the third flow control valve 70c, and the fourth flow control valve 70d, respectively, which are to be controlled by the control device 60.

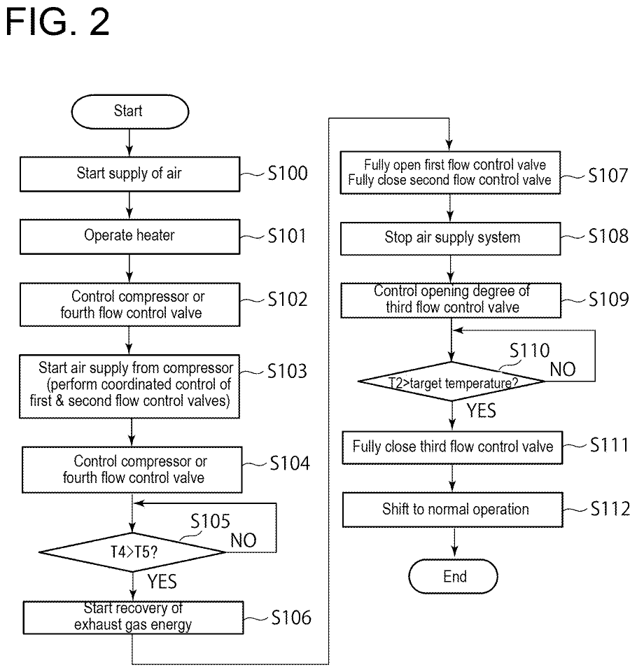

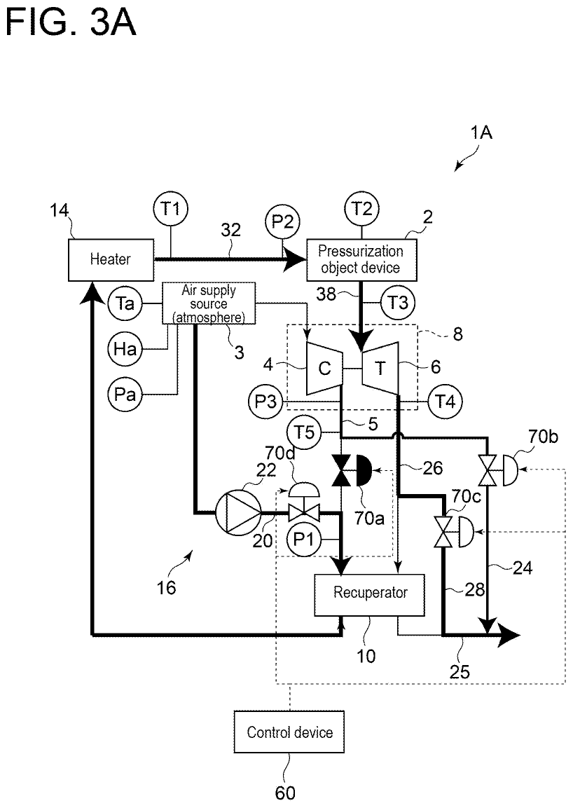

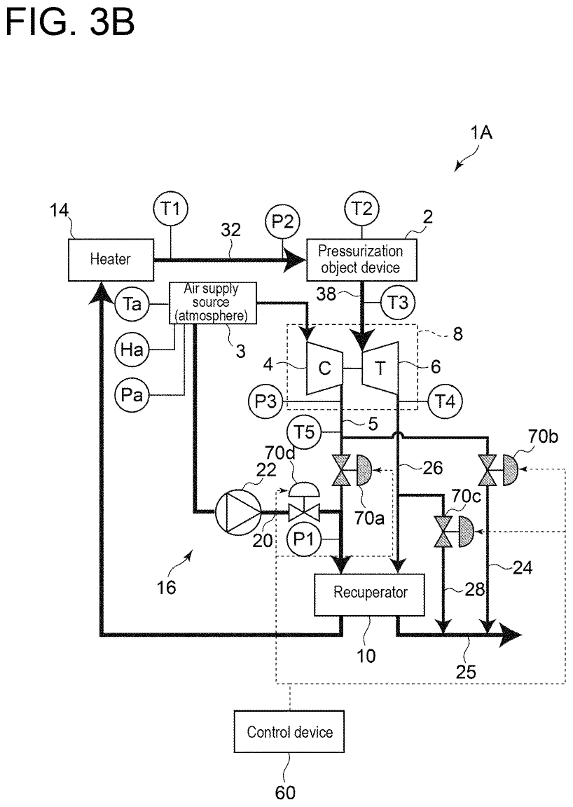

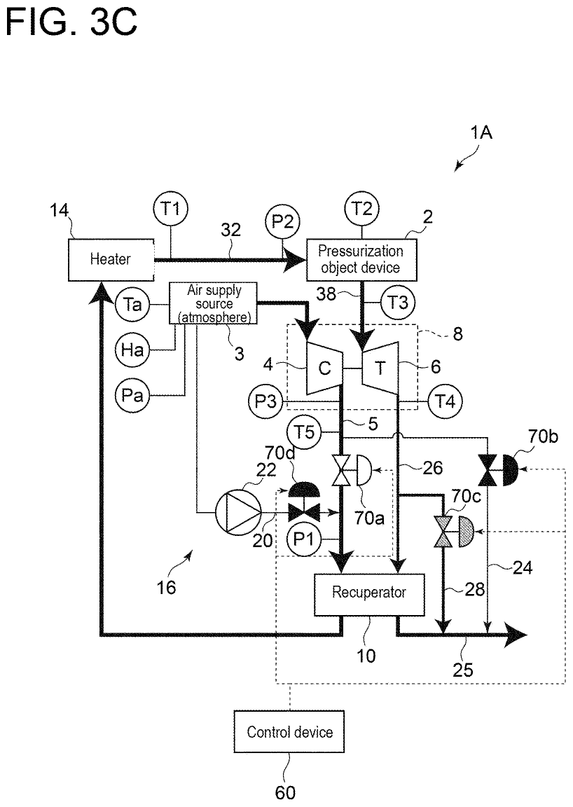

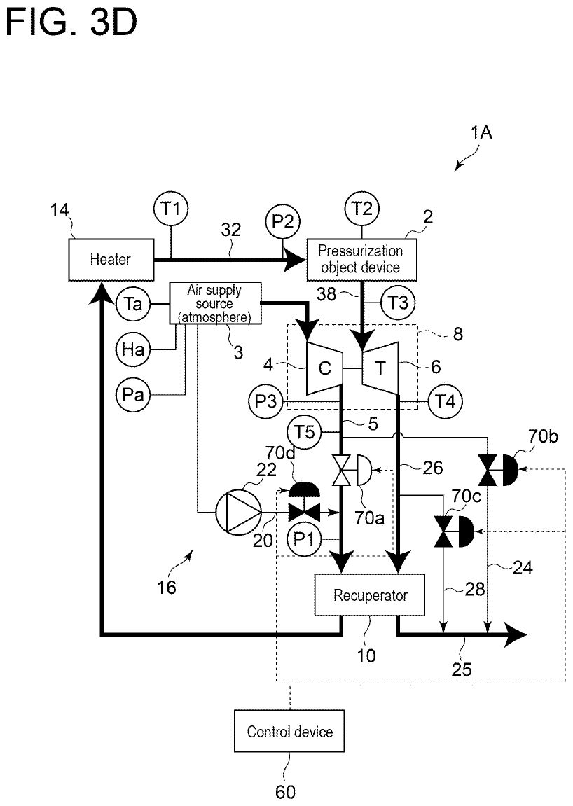

Subsequently, a method for starting the pressurized air supply system 1A of FIG. 1 will be described. FIG. 2 is a flowchart showing steps of the method for starting the pressurized air supply system 1A of FIG. 1. FIGS. 3A to 3D are each an overall configuration diagram showing an operating state of the pressurized air supply system 1A corresponding to the main steps of FIG. 2.

The pressurized air supply system 1A is set in an initial state shown in FIG. 1 at the start of startup. In the initial state, the first flow control valve 70a and the fourth flow control valve 70d are set in the fully closed state to prevent unintended air inflow to the downstream side of the recuperator 10. Further, the second flow control valve 70b and the third flow control valve 70c are set in the fully open state, there by configuring such that the inside of the system is opened to the outside and damage to the system can be prevented even if an unintended failure occurs.

First, the control device 60 starts the supply of the air from the air supply source 3 by the air supply system 16 (step S100). More specifically, as shown in FIG. 3A, the control device 60 switches the fourth flow control valve 70d to the fully open state from the aforementioned initial state (see FIG. 1), and starts the compressor 22. As a result, the air is supplied to the discharged air line 5 via the air line 20, and purging of an air system piping is started (see flow passages respectively indicated by thick arrows in FIG. 3A). Herein, if the temperature measured by the second temperature measuring device T2 is lower than the atmospheric temperature (outside air temperature) measured by the atmospheric temperature measuring device Ta, the air from the air supply source 3 is increased in temperature by the heater 14 to prevent the generation of the drain due to moisture in the air.

After the air from the air line 20 is supplied to the discharged air line 5, the control device 60 operates the heater 14 (step S101). Thus, the air from the air line 20 supplied to the discharged air line 5 is increased in temperature by the heater 14, and then supplied to the pressurization object device 2. In the pressurization object device 2, by supplying the heated air, the temperature gradually rises (so-called warm-up is performed).

Subsequently, the control device 60 controls the rotation speed of the compressor 22 or the opening degree of the fourth flow control valve 70d such that the temperature measured by the second temperature measuring device T2 is higher than a saturated steam temperature (step S102). Thus, the temperature of the flowing air in the pressurization object device 2 is maintained higher than the saturated steam temperature (dew point), preventing the generation of the drain in the pressurization object device 2.

The saturated steam temperature used in step S102 can be calculated based on the pressure and absolute humidity related to the flowing air of the pressurization object device 2. In the present embodiment, the pressure measured by the second pressure measuring device P2 is used as the pressure related to the flowing air of the pressurization object device 2. Further, the absolute humidity of the atmosphere which is calculated based on the atmospheric temperature (outside air temperature) measured by the atmospheric temperature measuring device Ta, the atmospheric pressure (outside air pressure) measured by the atmospheric pressure measuring device Pa, and the atmospheric air relative humidity measured by the atmospheric air relative humidity measuring device Ha is used as the absolute humidity of the flowing air of the pressurization object device 2.

In addition to the atmospheric air relative humidity measured by the atmospheric air relative humidity measuring device Ha, an element for adding water vapor to the air flowing through the system may be considered in calculation of the saturated steam temperature used in step S102. For example, if a burner for generating water vapor in fuel combustion is used as the heater 14, the amount of the water vapor generated by the combustion may be estimated based on the supply amount of the fuel input to the burner, and the estimation result may be considered in the calculation of the saturated steam temperature.

In the control of the opening degree of the fourth flow control valve 70d in step S102, if the temperature measured by the second temperature measuring device T2 is lower than the atmospheric temperature (outside air temperature) measured by the atmospheric temperature measuring device Ta, the opening degree control may be started after the opening degree of the fourth flow control valve 70d is initially set to a preset minimum opening degree. Thus, if the pressurization object device 2 is at the low temperature at the start of the control in step S102, the pressure of the object device can be kept low by suppressing the flow rate of the air to the pressurization object device 2, making it possible to suitably prevent the generation of the drain.

Further, the control device 60 may do monitoring so that the temperature measured by the first temperature measuring device T1 does not exceed a preset upper limit temperature threshold, after the heater 14 is started in step S101. Thus, it is possible to detect a defect, such as an excessive rise in outlet temperature of the heater 14, at an early stage, and to ensure good reliability.

Then, as shown in FIG. 3A, the air heated by the heater 14 is supplied to the turbine 6 after being supplied to the pressurization object device 2. Since the third flow control valve 70c is in the fully open state, most of the air having finished work in the turbine 6 is exhausted to the outside via the second bypass line 28.

At the stage of FIG. 3A, the turbine 6 is driven by the exhaust gas from the pressurization object device 2. However, the flow rate of the exhaust gas is low and the gas temperature is also low, and thus the power of the turbine 6 is also small. Therefore, since the pressure of the discharged air from the turbocharger compressor 4 is also lower than a downstream pressure of the first flow control valve 70a, the first flow control valve 70a is fully closed to exhaust the discharged air from the turbocharger compressor 4 to the outside via the first bypass line 24.

Subsequently, as shown in FIG. 3B, the control device 60 coordinately controls the opening degrees of the first flow control valve 70a and the second flow control valve 70b to start introduction of the discharged air from the turbocharger compressor 4 (step S103). More specifically, the control device 60 gradually decreases the opening degree of the second flow control valve 70b, which is in the fully open state in the initial state, as the output of the turbine 6 increases, thereby increasing the outlet pressure of the turbocharger compressor 4 (the pressure measured by the third pressure measuring device P3). Then, if the outlet pressure of the turbocharger compressor 4 becomes higher than the downstream pressure of the first flow control valve 70a (P3>P1), the opening degree of the first flow control valve 70a, which is in the fully closed state in the initial state, is gradually increased. As a result, the discharged air from the turbocharger compressor 4 whose pressure is increased by the aforementioned control of decreasing the opening degree of the second flow control valve 70b is introduced into the discharged air line 5.

The coordinated control of the first flow control valve 70a and the second flow control valve 70b in step S103 is performed so as to maintain a state where the pressure on the upstream side of the first flow control valve 70a (the pressure measured by the third pressure measuring device P3) is higher than the pressure on the downstream side of the first flow control valve 70a (the pressure measured by the first pressure measuring device P1). Thus, it is possible to introduce the discharged air from the turbocharger compressor 4 into the discharged air line 5 while preventing the air from the air line 20 from flowing back through the discharged air line 5.

Further, while the coordinated control of the first flow control valve 70a and the second flow control valve 70b in step S103 is performed, as with step S102 described above, the control device 60 controls the rotation speed of the compressor 22 or the opening degree of the fourth flow control valve 70d such that the temperature measured by the second temperature measuring device T2 is higher than the saturated steam temperature (step S104). As a result, also at the stage of FIG. 3B, it is possible to effectively prevent the generation of the drain in the pressurization object device 2.

Subsequently, the control device 60 controls the opening degree of the third flow control valve 70c such that the temperature measured by the second temperature measuring device T2 is higher than the saturated steam temperature (step S109). Thus, since the temperature of the flowing air in the pressurization object device 2 is maintained higher than the saturated steam temperature even after the air supply source to the system is switched to the turbocharger compressor 4, it is possible to prevent the generation of the drain in the pressurization object device 2.

Subsequently, if the temperature measured by the second temperature measuring device T2 is higher than the saturated steam temperature at the preset target pressure (step S110: YES), as shown in FIG. 3D, the control device 60 controls the third flow control valve 70c to be fully closed (step S111). As a result, the flow rate of the air flowing through the second bypass line 28 is cut off, and the entire flow rate of the exhaust gas exhausted from the turbine 6 is supplied to the recuperator 10 via the exhaust gas line 26, shifting to a steady operation state (step S112).

Further, in case the temperature measured by the second temperature measuring device T2 cannot maintain the saturated steam temperature even if the opening degree of the third flow control valve 70c is set in the fully closed state, the heat input from the heater 14 compensates. A series of starting methods are thus completed. However, if the pressurization object device 2 has a suitable temperature, instead of shifting the third flow control valve 70c to the fully closed state, the third flow control valve 70c may be controlled such that the temperature measured by the second temperature measuring device T2 becomes the suitable temperature.

Further, if the pressurization object device 2 is a device that internally generates heat (for example, the aforementioned SOFC or the like), the heater 14 may be switched to a non-operating state at a timing when the system becomes capable of independent operation.

As described above, according to the first embodiment, by coordinating the opening degrees of the respective flow control valves based on the measurement results by the measuring devices disposed in the respective sections of the system, smooth startup is possible while preventing the generation of the drain in the pressurization object device 2, without complicating the configuration.

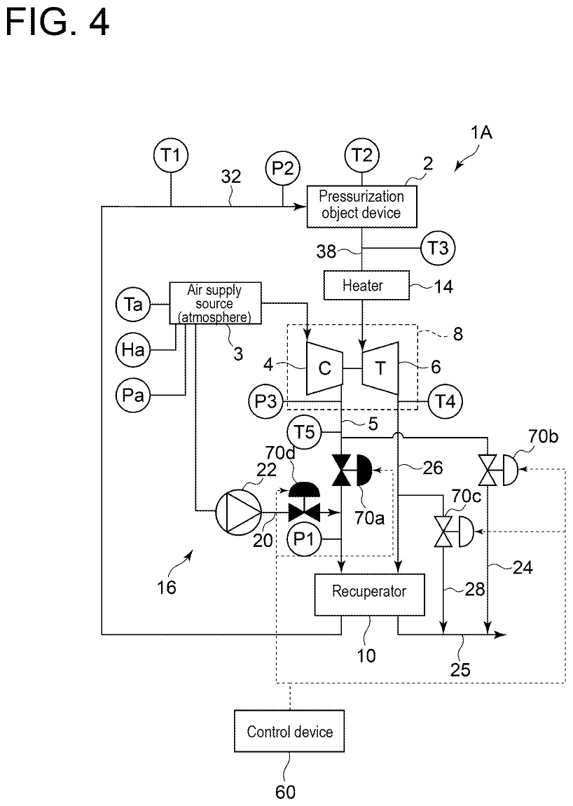

FIG. 4 is a modified example of FIG. 1. In the present modified example, the heater 14 is disposed on the used air line 38 through which the flowing air having passed through the pressurization object device 2 flows, thereby being configured to heat the flowing air having passed through the pressurization object device 2. The heater 14 heats the flowing air from the pressurization object device 2 and supplies the heated air to the turbine 6, thereby being able to increase the temperature of the exhaust gas supplied from the turbine 6 to the recuperator 10 via the exhaust gas line 26. Thus, it is possible to increase the temperature of the air supplied from the discharged air line 5 to the pressurization object device 2 by heat exchange in the recuperator 10.

In the modified example of FIG. 4, although there is such a difference in arrangement of the heater 14, other configurations are the same as those of the aforementioned first embodiment (FIGS. 1 to 3). Thus, by controlling opening/closing of the first flow control valve 70a, the second flow control valve 70b, the third flow control valve 70c, and the fourth flow control valve 70d in the same manner as in the aforementioned first embodiment, it is possible to heat the flowing air supplied to the pressurization object device 2 from at least one of the turbocharger compressor 4 or the air supply system 16 to prevent the generation of the drain in the pressurization object device 2. Further, by thus installing the heater 14 on the used air line 38 of the pressurization object device, it is possible to eliminate an influence of water vapor generation also in a heating method using a burner or the like, and it is possible to expect that the power of the turbocharger compressor is recovered more efficiently by the turbine.

In FIG. 4, the heater 14 is disposed downstream of the third temperature measuring device T3 on the used air line 38, thereby being configured to measure the temperature of the flowing air just having passed through the pressurization object device 2 by the third temperature measuring device T3.

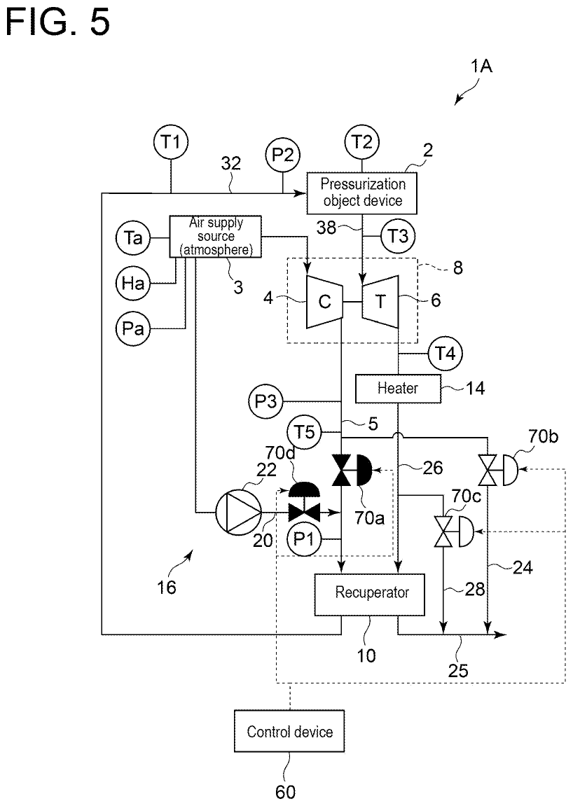

FIG. 5 is another modified example of FIG. 1. In the present modified example, the heater 14 is configured to heat the exhaust gas supplied from the turbine 6 to the recuperator 10. By heating the exhaust gas flowing through the exhaust gas line 26, it is possible to increase the temperature of the air supplied from the discharged air line 5 to the pressurization object device 2 by the heat exchange in the recuperator 10.

In the modified example of FIG. 5, although there is such a difference in arrangement of the heater 14, other configurations are the same as those of the aforementioned first embodiment (FIGS. 1 to 3). Thus, by controlling opening/closing of the first flow control valve 70a, the second flow control valve 70b, the third flow control valve 70c, and the fourth flow control valve 70d in the same manner as in the aforementioned second embodiment, it is possible to heat the flowing air supplied to the pressurization object device 2 from at least one of the turbocharger compressor 4 or the air supply system 16 to prevent the generation of the drain in the pressurization object device 2. Further, by installing the heater 14 on the used air line of the pressurization object device in the immediate vicinity of the recuperator 10, it is possible to heat more efficiently, and it is possible to eliminate the influence of water vapor generation also in the heating method using the burner or the like.

In FIG. 5, the heater 14 is disposed downstream of the fourth temperature measuring device T4 on the exhaust gas line 26, thereby being configured to measure the temperature of the exhaust gas from the turbine 6 by the fourth temperature measuring device T4.

In the aforementioned embodiment, the case where the pressurized air supply system 1A includes the single heater 14 is exemplified. However, the pressurized air supply system 1A may include a plurality of heaters 14. In this case, it is possible to place each heater 14 at any of a position where the flowing air supplied to the pressurization object device 2 can be heated (see FIGS. 1 to 3), a position where the flowing air having passed through the pressurization object device 2 can be heated (see FIG. 4), or a position where the exhaust gas supplied from the turbine 6 to the recuperator 10 can be heated (see FIG. 5).

Further, as the heating method by the heater, it is possible to combine various methods such as an electric heater, burner combustion, a heat exchanger method, and the like.

### Second Embodiment

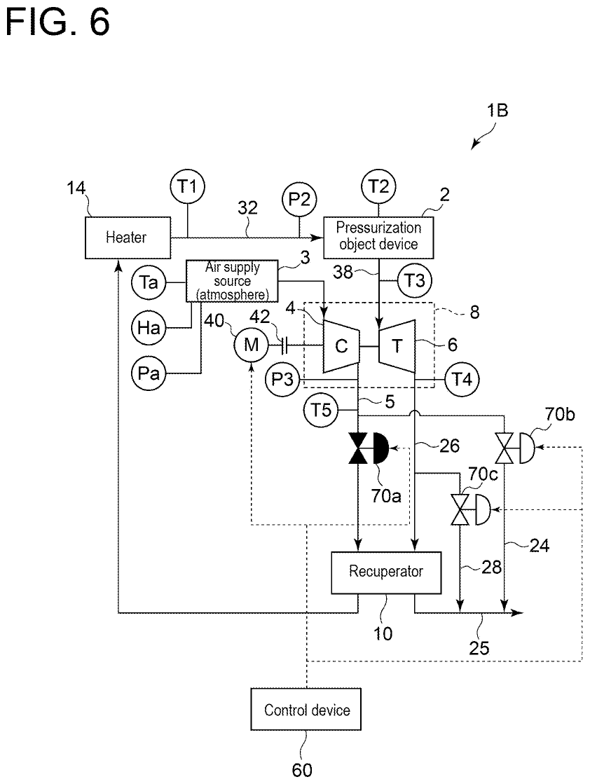

FIG. 6 is an overall configuration diagram of a pressurized air supply system 1B according to the second embodiment. The pressurized air supply system 1B partially has the same configuration as the pressurized air supply system 1A according to the aforementioned first embodiment, but includes a motor 40 for driving the turbocharger turbocharger compressor 4 mainly in place of the air supply system 16. In the following description, common reference symbols will be used for the configuration common to the pressurized air supply system 1A in the pressurized air supply system 1B, and overlapping description will be omitted as appropriate.

The turbocharger compressor 4 is connected to the motor 40 via a clutch 42. The clutch 42 is configured to selectively switch between a connected state and a disconnected state based on a control signal from the control device 60, and can operate the turbocharger compressor 4 at any timing by the power output from the motor 40. More specifically, the control device 60 operates the turbocharger compressor 4 by using the motor 40 when the system is started, thereby allowing the turbocharger compressor 4 to supply air to the system even in a state where the exhaust gas flow rate in the turbine 6 is low.

The pressurized air supply system 1B includes at least one flow control valve for controlling the flow rate of the flowing air flowing into the heater 14. In the second embodiment, as the flow control valve, the pressurized air supply system 1B includes the first flow control valve 70a disposed on the discharged air line 5, the second flow control valve 70b disposed on the first bypass line 24, and the third flow control valve 70c disposed on the second bypass line 28. The first flow control valve 70a is configured such that the flow rate of the air supplied to the heater 14 becomes variable by adjusting the opening degree of the first flow control valve 70a. The second flow control valve 70b is configured such that the flow rate of the air flowing through the first bypass line 24 becomes variable by adjusting the opening degree of the second flow control valve 70b. The third flow control valve 70c is configured such that the flow rate of the air flowing through the second bypass line 28 becomes variable by adjusting the opening degree of the third flow control valve 70c.

Further, in the present system, the rotation speed of the motor may be controlled by an inverter to change the flow rate of the air supplied to the discharged air line 5.

As with the aforementioned pressurized air supply system 1A, the pressurized air supply system 1B includes the temperature measuring device (the first temperature measuring device T1, the second temperature measuring device T2, the third temperature measuring device T3, the fourth temperature measuring device T4, the fifth temperature measuring device T5, the atmospheric temperature measuring device Ta) for measuring the temperature in each part, the pressure measuring device (the second pressure measuring device P2, the third pressure measuring device P3, the atmospheric pressure measuring device Pa; note that the first pressure measuring device P1 is omitted), and the atmospheric air relative humidity measuring device Ha.

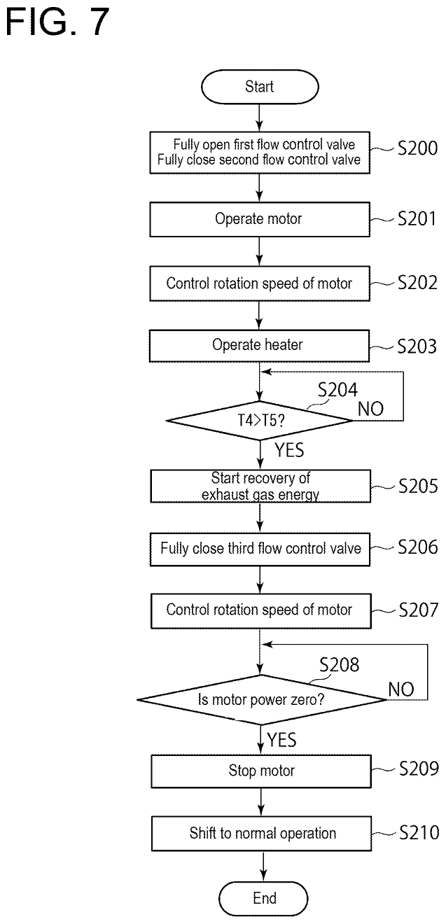

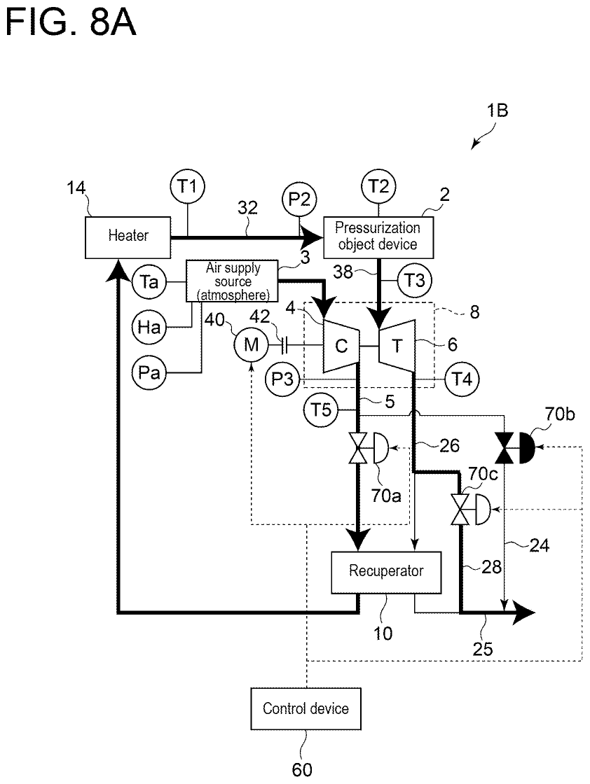

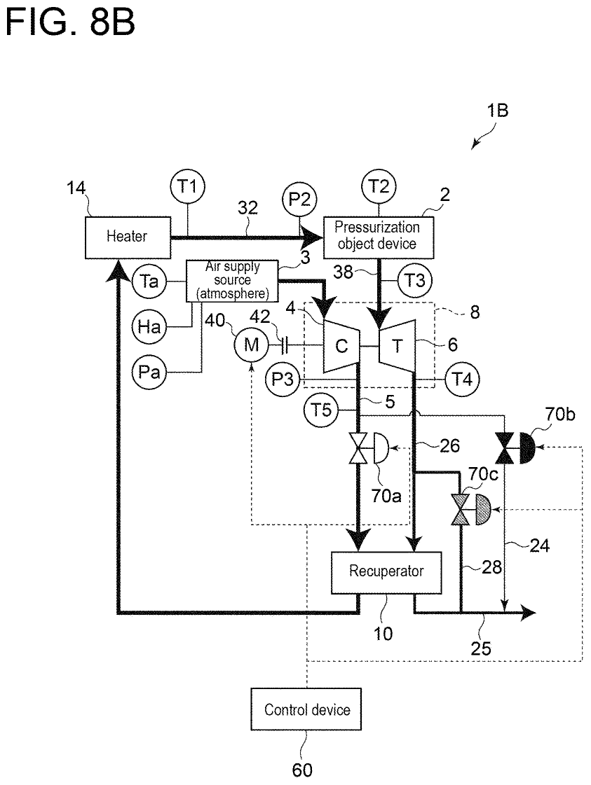

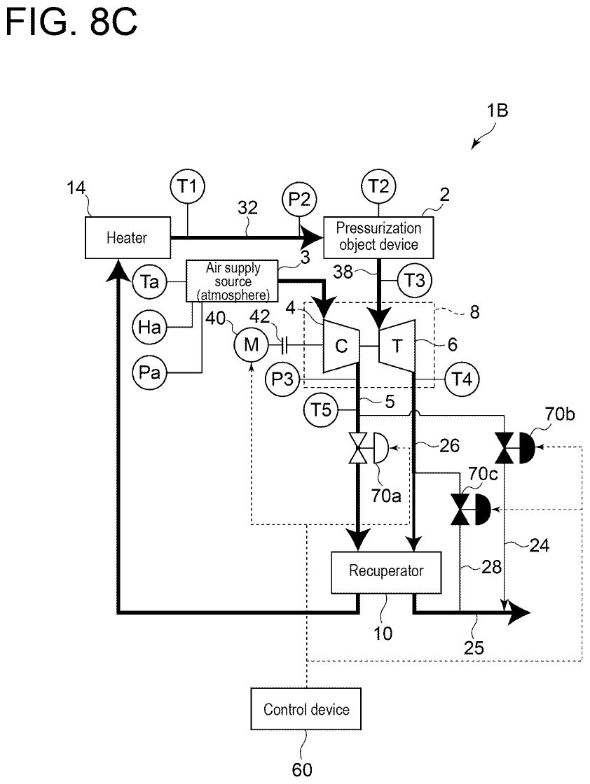

Subsequently, a method for starting the pressurized air supply system 1B of FIG. 6 will be described. FIG. 7 is a flowchart showing steps of the method for starting the pressurized air supply system 10B of FIG. 6. FIGS. 8A to 8C are each an overall configuration diagram of the pressurized air supply system 1B corresponding to the main steps of FIG. 7.

First, the pressurized air supply system 1B is in an initial state shown in FIG. 6 at the start of startup. In the initial state, the first flow control valve 70a is set in the fully closed state to prevent unintended air inflow to the downstream side of the recuperator 10. Further, the second flow control valve 70b and the third flow control valve 70c are set in the fully open state, thereby configuring such that the inside of the system is opened to the outside and damage to the system can be prevented even if an unintended failure occurs.

Herein, the first flow control valve 70a can be omitted if there is no possibility that air flows into the pressurization object device 2 or the like, and further the second flow control valve 70b and the first bypass line 24 can also be omitted if the pressure of the pressurization object device 3 is regulated or the supply air flow rate is adjusted only by the rotation speed of the motor.

First, as shown in FIG. 8A, the control device 60 switches the first flow control valve 70a which is in the fully closed state in the initial state to the fully open state, and switches the second flow control valve 70b which is in the fully open state in the initial state to the fully closed state (step S200), and further switches the clutch 42 to the connected state to operate the motor 40 (step S201). Thus, since the first flow control valve 70a is in the fully open state, the discharged air from the turbocharger compressor 4 is supplied to the side of the recuperator 10 via the discharged air line 5.

As the starting operation, after the operation of the motor 40 is preceded, the open/closed state of the first flow control valve 70a and the second flow control valve 70b may be switched (the order of step S201 and step S200 may be changed).

In step S200, if the temperature measured by the second temperature measuring device T2 is lower than the atmospheric temperature (outside air temperature) measured by the atmospheric temperature measuring device Ta, control may be performed as needed such that the opening degree of the first flow control valve 70a is decreased and/or the opening degree of the second flow control valve 70b is increased. Thus, if the pressurization object device 2 is at the low temperature, the pressure of the object device can be kept low by suppressing the flow rate of the air to the pressurization object device 2, making it possible to suitably prevent the generation of the drain.

Subsequently, the control device 60 controls the rotation speed of the motor such that the temperature measured by the second temperature measuring device T2 is higher than the saturated steam temperature (step S202). Thus, the temperature of the flowing air in the pressurization object device 2 is maintained higher than the saturated steam temperature, making it possible to prevent the generation of the drain in the pressurization object device 2. As with the aforementioned first embodiment, the saturated steam temperature used in step S202 can be calculated based on the pressure and absolute humidity related to the flowing air of the pressurization object device 2.

Then, when sufficient air for the operation of the heater 14 is supplied to the discharged air line 5, the control device 60 starts the heater 14 (step S203). Thus, the air supplied to the discharged air line 5 is increased in temperature by the heater 14, and then supplied to the pressurization object device 2.

Subsequently, if the temperature (turbine outlet temperature) measured by the fourth temperature measuring device T4 is higher than an outlet temperature T5 of the turbocharger compressor 4 (step S204: YES), the control device 60 starts recovery of thermal energy contained in the exhaust gas from the turbine 6 (step S205), as shown in FIG. 8B. More specifically, by decreasing the opening degree of the third flow control valve 70c disposed on the second bypass line 28, the flow rate of the exhaust gas flowing through the second bypass line 28 is decreased and the flow rate of the exhaust gas flowing through the recuperator 10 is increased accordingly, promoting the heat recovery of the exhaust gas by the recuperator 10.

Subsequently, as shown in FIG. 8C, the control device 60 fully closes the third flow control valve 70c (step S206), and controls the rotation speed of the motor such that the temperature measured by the second temperature measuring device T2 is higher than the saturated steam temperature (step S207). As a result, the flow rate of the air flowing through the second bypass line 28 is cut off, making it possible to prevent the generation of the drain in the pressurization object device 2 even in the case where the entire flow rate of the exhaust gas exhausted from the turbine 6 is supplied to the recuperator 10 via the exhaust gas line 26.

As for the power of the motor 40, recovery power of the turbine 6 increases as the temperature of the exhaust gas from the pressurization object device 2 increases, and along therewith, the power of the motor 40 gradually decreases to become substantially zero. Subsequently, if the power of the motor 40 becomes substantially zero (step S208: YES), the control device 60 switches the clutch 42 to the disconnected state to stop the motor 40 (step S209), and shifts to a normal operation (step S210). A series of starting methods are thus completed. However, if the pressurization object device 2 has a suitable temperature, instead of shifting the third flow control valve 70c to the fully closed state, the third flow control valve 70c may be controlled such that the temperature measured by the second temperature measuring device T2 becomes the suitable temperature.

Further, if the temperature measured by the second temperature measuring device T2 cannot maintain the saturated steam temperature even if the opening degree of the third flow control valve 70c is set in the fully closed state, the heat input from the heater compensates. If the pressurization object device 2 is the device that internally generates heat (for example, the aforementioned SOFC or the like), the heater 14 may be switched to the non-operating state at the timing when the system becomes capable of independent operation.

As described above, according to the second embodiment, by coordinating the opening degrees of the respective flow control valves based on the measurement results by the measuring devices disposed in the respective sections of the system, smooth startup is possible while preventing the generation of the drain in the pressurization object device 2, without complicating the configuration.

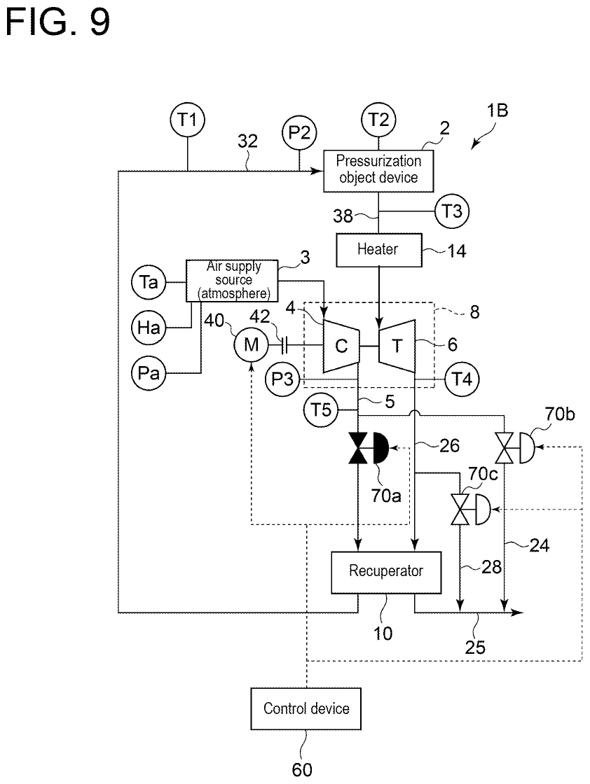

FIG. 9 is a modified example of FIG. 6. In the present modified example, the heater 14 is disposed on the used air line 38 through which the flowing air having passed through the pressurization object device 2 flows, thereby being configured to heat the flowing air having passed through the pressurization object device 2. The heater 14 heats the flowing air from the pressurization object device 2 and supplies the heated air to the turbine 6, thereby being able to increase the temperature of the exhaust gas supplied from the turbine 6 to the recuperator 10 via the exhaust gas line 26. Thus, it is possible to increase the temperature of the air supplied from the discharged air line 5 to the pressurization object device 2 by heat exchange in the recuperator 10.

By installing the heater 14 upstream of the turbine 6, the temperature of the used air at the turbine inlet increases and the output of the turbine increases, making it possible to reduce the motor power. Further, by installing the heater 14 on the used air line of the pressurization object device, it is possible to eliminate the influence of water vapor generation also in the heating method using the burner or the like.

In the modified example of FIG. 9, although there is such a difference in arrangement of the heater 14, other configurations are the same as those of the aforementioned second embodiment (FIGS. 6 to 8). Thus, by controlling opening/closing of the first flow control valve 70a, the second flow control valve 70b, and the third flow control valve 70c in the same manner as in the aforementioned second embodiment, it is possible to heat the flowing air supplied to the pressurization object device 2 from the turbocharger compressor 4 via the discharged line 5 to prevent the generation of the drain in the pressurization object device 2.

In FIG. 9, the heater 14 is disposed downstream of the third temperature measuring device T3 on the used air line 38, thereby being configured to measure the temperature of the flowing air just having passed through the pressurization object device 2 by the third temperature measuring device T3.

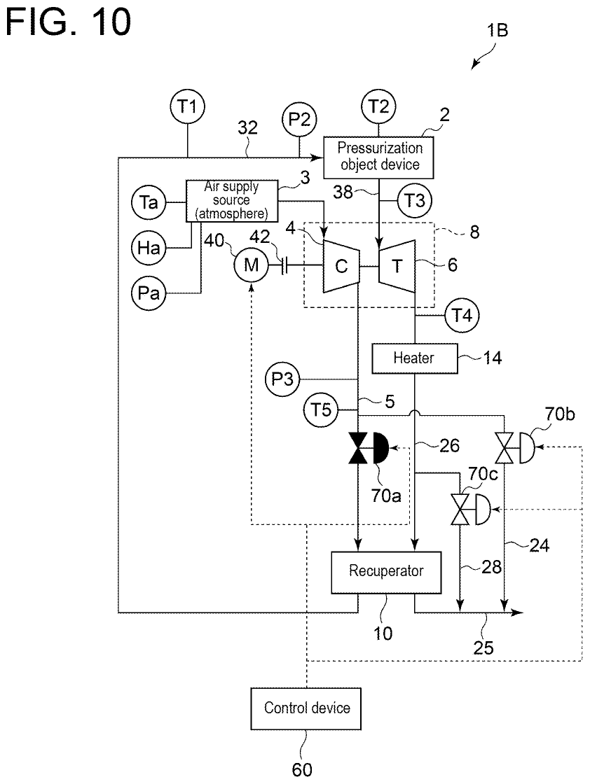

FIG. 10 is another modified example of FIG. 6. In the present modified example, the heater 14 is configured to heat the exhaust gas supplied from the turbine 6 to the recuperator 10. By heating the exhaust gas flowing through the exhaust gas line 26, it is possible to increase the temperature of the air supplied from the discharged air line 5 to the pressurization object device 2 by the heat exchange in the recuperator 10.

Further, by installing the heater 14 on the used air line of the pressurization object device in the immediate vicinity of the recuperator 10, it is possible to heat more efficiently, and it is possible to eliminate the influence of water vapor generation also in the heating method using the burner or the like.

In the modified example of FIG. 10, although there is such a difference in arrangement of the heater 14, other configurations are the same as those of the aforementioned second embodiment (FIGS. 6 to 8). Thus, by controlling opening/closing of the first flow control valve 70a, the second flow control valve 70b, and the third flow control valve 70c in the same manner as in the aforementioned second embodiment, it is possible to heat the flowing air supplied to the pressurization object device 2 from the turbocharger compressor 4 via the discharged air line 5 to prevent the generation of the drain in the pressurization object device 2.

In FIG. 10, the heater 14 is disposed downstream of the fourth temperature measuring device T4 on the exhaust gas line 26, thereby being configured to measure the temperature of the exhaust gas from the turbine 6 by the fourth temperature measuring device T4.

In the aforementioned embodiment, the case where the pressurized air supply system 1B includes the single heater 14 is exemplified. However, the pressurized air supply system 1B may include a plurality of heaters 14. In this case, it is possible to place each heater 14 at any of a position where the flowing air supplied to the pressurization object device 2 can be heated (see FIGS. 6 to 8), a position where the flowing air having passed through the pressurization object device 2 can be heated (see FIG. 9), or a position where the exhaust gas supplied from the turbine 6 to the recuperator 10 can be heated (see FIG. 10).

Further, as the heating method by the heater, it is possible to combine various methods such as an electric heater, burner combustion, a heat exchanger method, and the like.

As for the rest, without departing from the spirit of the present disclosure, it is possible to replace the constituent elements in the above-described embodiments with known constituent elements, respectively, as needed and further, the above-described embodiments may be combined as needed.

The contents described in the above embodiments would be understood as follows, for instance.

(1) A pressurized air supply system (such as the pressurized air supply system 1A, 1B of the above-described embodiment) according to an aspect of the present disclosure includes a turbocharger (such as the turbocharger 8 of the above-described embodiment) including a turbine (such as the turbine 6 of the above-described embodiment) and a compressor (such as the turbocharger compressor 4 of the above-described embodiment), a recuperator (such as the recuperator 10 of the above-described embodiment) for performing heat exchange between discharged air from the compressor and an exhaust gas exhausted from the turbine, a pressurization object device (such as the pressurization object device 2 of the above-described embodiment) that is supplied with flowing air which includes at least one of the discharged air or air supplied to a discharged air line (such as the discharged air line 5 of the above-described embodiment) from the compressor to the recuperator, the pressurization object device being configured to exhaust the flowing air to the turbine, a heater (such as the heater 14 of the above-described embodiment) configured to heat at least one of the flowing air supplied to the pressurization object device, the flowing air having passed through the pressurization object device, or the exhaust gas supplied from the turbine to the recuperator, a flow control valve (such as the first flow control valve 70a, the second flow control valve 70b, the third flow control valve 70c, the fourth flow control valve 70d of the above-described embodiment) for controlling a flow rate of the flowing air flowing into the heater, and a control device (such as the control device 60 of the above-described embodiment) for controlling an opening degree of the flow control valve. The control device controls the opening degree of the flow control valve such that a temperature of the flowing air passing through the pressurization object device (such as the temperature measured by the second temperature measuring device T2 of the above-described embodiment) is higher than the saturated steam temperature of the flowing air passing through the pressurization object device.

With the above aspect (1), since the opening degree of the flow control valve is controlled such that the temperature of the flowing air passing through the pressurization object device is higher than the saturated steam temperature, it is possible to prevent the generation of the drain in the pressurization object device. Such control can be performed by controlling the temperature or the pressure in the system with reference to the saturated steam temperature that can be calculated based on the measurement result by the sensor or the like disposed in each part of the system, and it is possible to effectively prevent the generation of the drain without complicating the system configuration.

(2) In another embodiment, in the above aspect (1), the heater (such as the heater 14 in FIGS. 1 and 6 of the above-described embodiment) is configured to heat the flowing air supplied to the pressurization object device.

With the above aspect (2), since the heater heats the flowing air supplied to the pressurization object device, it is possible to make the temperature of the flowing air in the pressurization object device higher than the saturated steam temperature, and it is possible to prevent the generation of the drain in the pressurization object device.

(3) In another embodiment, in the above aspect (1), the heater (such as the heater 14 in FIGS. 4 and 9 of the above-described embodiment) is configured to heat the flowing air having passed through the pressurization object device.

With the above aspect (3), since the heater heats the flowing air having passed through the pressurization object device, it is possible to increase the temperature of the exhaust gas exhausted from the turbine. As a result, the discharged air from the compressor, which exchanges heat with the exhaust gas in the recuperator, is increased in temperature, and the flowing air supplied to the pressurization object device is heated. Thus, it is possible to make the temperature of the flowing air in the pressurization object device higher than the saturated steam temperature, and it is possible to prevent the generation of the drain in the pressurization object device.

(4) In another embodiment, in the above aspect (1), the heater (such as the heater 14 in FIGS. 5 and 10 of the above-described embodiment) is configured to heat the exhaust gas supplied from the turbine to the recuperator.

With the above aspect (4), since the heater heats the exhaust gas exhausted from the turbine, it is possible to increase the temperature of the discharged air from the compressor which exchanges heat with the exhaust gas in the recuperator. As a result, it is possible to make the temperature of the flowing air supplied to the pressurization object device higher than the saturated steam temperature, and it is possible to prevent the generation of the drain in the pressurization object device.

(5) In another aspect, in any one of the above aspects (1) to (4), the control device calculates the saturated steam temperature, based on a pressure and a temperature of the flowing air passing through the pressurization object device as well as absolute humidity of intake air of the compressor.

With the above aspect (5), it is possible to accurately estimate the saturated steam temperature used for control, based on the measurement result by the sensor or the like disposed in each part of the system.

(6) In another aspect, in any one of the above aspects (1) to (5), the pressurized air supply system further includes an air line (such as the air line 20 of the above-described embodiment) for supplying the air, a first bypass line (such as the first bypass line 24 of the above-described embodiment) for allowing the discharged air to bypass the recuperator, an exhaust gas line (such as the exhaust gas line 26 of the above-described embodiment) for exhausting the exhaust gas from the turbine, and a second bypass line (such as the second bypass line 28 of the above-described embodiment) for allowing the exhaust gas to bypass the recuperator. The flow control valve includes a first flow control valve (such as the first flow control valve 70a of the above-described embodiment) for controlling a flow rate in the discharged air line, a second flow control valve (such as the second flow control valve 70b of the above-described embodiment) for controlling a flow rate in the first bypass line, a third flow control valve (such as the third flow control valve 70c of the above-described embodiment) for controlling a flow rate in the second bypass line, and a fourth flow control valve (such as the fourth flow control valve 70d of the above-described embodiment) for controlling a flow rate in the air line.

With the above aspect (6), it is possible to effectively prevent the generation of the drain in the pressurization object device in the configuration capable of supplying air which is available instead of the discharged air from the compressor at startup.

(7) In another aspect, in the above aspect (6), the control device controls a supply amount of the air such that a temperature of the flowing air passing through the pressurization object device is higher than the saturated steam temperature, if the first flow control valve is in a closed state.

With the above aspect (7), since the supply amount of the air is controlled when the air is supplied to the pressurization object device at startup, the temperature of the flowing air passing through the pressurization object device is maintained higher than the saturated steam temperature. Thus, it is possible to effectively prevent the generation of the drain in the pressurization object device.

(8) In another aspect, in the above aspect (6), the control device controls a supply amount of the flowing air to the pressurization object device such that a temperature of the flowing air passing through the pressurization object device is higher than the saturated steam temperature, if the first flow control valve is in an open state.

With the above aspect (8), in the situation where the discharged air of the compressor is supplied to the system due to the open state of the first flow control valve, the temperature of the flowing air passing through the pressurization object device is maintained higher than the saturated steam temperature by controlling the supply amount of the flowing air to the pressurization object device. Thus, it is possible to effectively prevent the generation of the drain in the pressurization object device. For example, if the fourth flow control valve is also in the open state in addition to the first flow control valve, the supply amount of the flowing air to the pressurization object device may be controlled by controlling the supply amount of the air in the same manner as in the above aspect (4). Further, if the fourth flow control valve is in the closed state, the supply amount of the flowing air to the pressurization object device may be controlled by controlling the supply amount of the discharged air of the compressor, by adjusting the rotation speed of the compressor or the opening degree of the flow control valve.

(9) In another aspect, in any one of the above aspects (6) to (8), the control device controls the flow control valve so as to switch air supplied to the discharged air line from the air to discharged air of the compressor, while maintaining a state where a temperature of the flowing air passing through the pressurization object device is higher than the saturated steam temperature.

With the above aspect (9), also when the air supplied to the discharged air line is switched from the air to the discharged air of the compressor, by the control of the flow control valve, it is possible to maintain the temperature of the flowing air passing through the pressurization object device higher than the saturated steam temperature, and to prevent the generation of the drain in the pressurization object device.

(10) In another aspect, in any one of the above aspects (6) to (9), the control device decreases an opening degree of the third flow control valve, if a temperature in the exhaust gas line is higher than a temperature in the discharged air line.

With the above aspect (10), since the opening degree of the third flow control valve is decreased if the temperature of the exhaust gas from the turbine is sufficiently increased, the amount of the exhaust gas introduced into the recuperator is increased, making it possible to promote heat recovery.

(11) In another aspect, in the above aspect (10), the control device controls the opening degree of the third flow control valve such that a temperature of the flowing air passing through the pressurization object device is higher than the saturated steam temperature.

With the above aspect (11), also when the opening degree of the third flow control valve is decreased, by the control of the third flow control valve, since the temperature of the flowing air passing through the pressurization object device is maintained higher than the saturated steam temperature, it is possible to prevent the generation of the drain in the pressurization object device.

(12) In another aspect, in any one of the above aspects (1) to (5), the pressurized air supply system further includes a starting motor (such as the starting motor 40 of the above-described embodiment) for driving the compressor, a first bypass line (such as the first bypass line 24 of the above-described embodiment) for allowing the discharged air to bypass the recuperator, an exhaust gas line (such as the exhaust gas line 26 of the above-described embodiment) for exhausting the exhaust gas from the turbine, and a second bypass line (such as the second bypass line 28 of the above-described embodiment) for allowing the exhaust gas to bypass the recuperator. The flow control valve includes a first flow control valve (such as the first flow control valve 70a of the above-described embodiment) for controlling a flow rate in the discharged air line, a second flow control valve (such as the second flow control valve 70b of the above-described embodiment) for controlling a flow rate in the first bypass line, and a third flow control valve (such as the third flow control valve 70c of the above-described embodiment) for controlling a flow rate in the second bypass line.

With the above aspect (12), it is possible to effectively prevent the generation of the drain in the pressurization object device in the configuration where the compressor can be driven from startup by using the starting motor.

(13) In another aspect, in the above aspect (12), the control device controls a rotation speed of the starting motor such that a temperature of the flowing air passing through the pressurization object device is higher than the saturated steam temperature, if the first flow control valve is in an open state.

With the above aspect (13), since the rotation speed of the starting motor is controlled, it is possible to maintain the temperature of the flowing air passing through the pressurization object device higher than the saturated steam temperature. Thus, it is possible to prevent the generation of the drain in the pressurization object device when the discharged air is supplied from the compressor.

(14) In another aspect, in the above aspect (12) or (13), the control device decreases an opening degree of the third flow control valve, if a temperature in the exhaust gas line is higher than a temperature of discharged air from the compressor.

With the above aspect (14), since the opening degree of the third flow control valve is decreased if the temperature of the exhaust gas from the turbine is sufficiently increased, the amount of the exhaust gas introduced into the recuperator is increased, making it possible to promote heat recovery.

(15) In another aspect, in the above aspect (14), the control device controls the opening degree of the third flow control valve such that a temperature of the flowing air passing through the pressurization object device is higher than the saturated steam temperature.

With the above aspect (15), also when the opening degree of the third flow control valve is decreased, by the control of the third flow control valve, it is possible to maintain the temperature of the flowing air passing through the pressurization object device higher than the saturated steam temperature, and to prevent the generation of the drain.

(16) A method for starting a pressurized air supply system according to an aspect of the present disclosure is a method for starting a pressurized air supply system (such as the pressurized air supply system 1A, 1B of the above-described embodiment) that includes a turbocharger (such as the turbocharger 8 of the above-described embodiment) including a turbine (such as the turbine 6 of the above-described embodiment) and a compressor (such as the turbocharger compressor 4 of the above-described embodiment), a recuperator (such as the recuperator 10 of the above-described embodiment) for performing heat exchange between discharged air from the compressor and an exhaust gas exhausted from the turbine, a pressurization object device (such as the pressurization object device 2 of the above-described embodiment) that is supplied with flowing air which includes at least one of the discharged air or air supplied to a discharged air line (such as the discharged air line 5 of the above-described embodiment) from the compressor to the recuperator, the pressurization object device being configured to exhaust the flowing air to the turbine, a heater (such as the heater 14 of the above-described embodiment) configured to heat at least one of the flowing air supplied to the pressurization object device, the flowing air having passed through the pressurization object device, or the exhaust gas supplied from the turbine to the recuperator, and a flow control valve (such as the first flow control valve 70a, the second flow control valve 70b, the third flow control valve 70c, the fourth flow control valve 70d of the above-described embodiment) for controlling a flow rate of the flowing air flowing into the heater. The opening degree of the flow control valve is controlled such that a temperature of the flowing air passing through the pressurization object part is higher than a saturated steam temperature of the flowing air passing through the pressurization object part.

With the above aspect (16), since the opening degree of the flow control valve is controlled such that the temperature of the flowing air passing through the pressurization object device is higher than the saturated steam temperature, it is possible to prevent the generation of the drain in the pressurization object device. Such control can be performed by controlling the temperature or the pressure in the system with reference to the saturated steam temperature that can be calculated based on the measurement result by the sensor or the like disposed in each part of the system, and it is possible to effectively prevent the generation of the drain without complicating the system configuration.

### REFERENCE SIGNS LIST

1A, 1B Pressurized air supply system
2 Pressurization object device
3 Air supply source
4 Turbocharger compressor
5 Discharged air line
6 Turbine
8 Turbocharger
10 Recuperator
14 Heater
16 Air supply system
20 Air line
22 Compressor
24 First bypass line
26 Exhaust gas line
28 Second bypass line
32 Heated air line
38 Used air line
40 Motor
42 Clutch
60 Control device
70 Flow control valve
70a First flow control valve
70b Second flow control valve
70c Third flow control valve
70d Fourth flow control valve
T1 First temperature measuring device
T2 Second temperature measuring device
T3 Third temperature measuring device
T4 Fourth temperature measuring device
T5 Fifth temperature measuring device
Ta Atmospheric temperature measuring device
P1 First pressure measuring device
P2 Second pressure measuring device
P3 Third pressure measuring device
Ha Atmospheric air relative humidity measuring device

1. A pressurized air supply system, comprising:
a turbocharger including a turbine and a turbocharger compressor;
a recuperator for performing heat exchange between discharged air from the turbocharger compressor and an exhaust gas exhausted from the turbine;
a compressor capable of compressing air supplied from an air supply source;
a pressurization object device that is supplied with flowing air which includes at least one of the discharged air or compressed air generated by the compressor, the pressurization object device being configured to exhaust the flowing air to the turbine; and
a heater configured to heat the flowing air supplied to the pressurization object device,
wherein the compressor is controlled such that a saturated steam temperature of the flowing air supplied from the air supply source to the pressurization object device is lower than a temperature in the pressurization object device, at startup.

2. The pressurized air supply system according to claim 1,
wherein the heater is configured to heat the flowing air having passed through the pressurization object device.

3. The pressurized air supply system according to claim 1,
wherein the heater is configured to heat the exhaust gas supplied from the turbine to the recuperator.

4. The pressurized air supply system according to claim 1, further comprising a control device for controlling the pressurized air supply system,
wherein the control device calculates the saturated steam temperature, based on a pressure and a temperature of the flowing air passing through the pressurization object device as well as absolute humidity of intake air of the turbocharger compressor.

5. The pressurized air supply system according to claim 1, further comprising:
an air line for supplying the air;
a first bypass line bypassing a flowing air side of the recuperator;
an exhaust gas line for exhausting the exhaust gas from the turbine;
a second bypass line bypassing an exhaust gas side of the recuperator; and
a flow control valve for controlling a flow rate of the flowing air flowing into the heater,
wherein the flow control valve includes:
a first flow control valve for controlling a flow rate in the discharged air line;
a second flow control valve for controlling a flow rate in the first bypass line;
a third flow control valve for controlling a flow rate in the second bypass line; and
a fourth flow control valve for controlling a flow rate in the air line.

6. The pressurized air supply system according to claim 5,
wherein the control device controls a supply amount of the air such that a temperature of the flowing air passing through the pressurization object device is higher than the saturated steam temperature, if the first flow control valve is in a closed state.

7. The pressurized air supply system according to claim 5,
wherein the control device controls a supply amount of the flowing air to the pressurization object device such that a temperature of the flowing air passing through the pressurization object device is higher than the saturated steam temperature, if the first flow control valve is in an open state.

8. The pressurized air supply system according to claim 5,
wherein the control device controls the flow control valve so as to switch air supplied to the discharged air line from the air to discharged air of the compressor, while maintaining a state where a temperature of the flowing air passing through the pressurization object device is higher than the saturated steam temperature.

9. The pressurized air supply system according to claim 5,
wherein the control device decreases an opening degree of the third flow control valve, if a temperature in the exhaust gas line is higher than a temperature in the discharged air line.

10. The pressurized air supply system according to claim 9,
wherein the control device controls the opening degree of the third flow control valve such that a temperature of the flowing air passing through the pressurization object device is higher than the saturated steam temperature.

11. The pressurized air supply system according to claim 1, further comprising:
a motor for driving the turbocharger compressor;
a first bypass line bypassing a flowing air side of the recuperator;
an exhaust gas line for exhausting the exhaust gas from the turbine;
a second bypass line bypassing an exhaust gas side of the recuperator; and
a flow control valve for controlling a flow rate of the flowing air flowing into the heater,
wherein the flow control valve includes:
a first flow control valve for controlling a flow rate in the discharged air line;
a second flow control valve for controlling a flow rate in the first bypass line; and
a third flow control valve for controlling a flow rate in the second bypass line.

12. The pressurized air supply system according to claim 11,
wherein the control device controls a rotation speed of the motor such that a temperature of the flowing air passing through the pressurization object device is higher than the saturated steam temperature, if the first flow control valve is in an open state.

13. The pressurized air supply system according to claim 11
wherein the control device decreases an opening degree of the third flow control valve, if a temperature in the exhaust gas line is higher than a temperature of discharged air from the compressor.

14. The pressurized air supply system according to claim 13,
wherein the control device controls the opening degree of the third flow control valve such that a temperature of the flowing air passing through the pressurization object device is higher than the saturated steam temperature.

15. A method for starting a pressurized air supply system that includes:
a turbocharger including a turbine and a turbocharger compressor;
a recuperator for performing heat exchange between discharged air from the compressor and an exhaust gas exhausted from the turbine;
a compressor capable of compressing air supplied from an air supply source;
a pressurization object device that is supplied with flowing air which includes at least one of the discharged air or compressed air generated by the compressor, the pressurization object device being configured to exhaust the flowing air to the turbine; and
a heater configured to heat the flowing air supplied to the pressurization object device,
wherein the compressor is controlled such that a saturated steam temperature of the flowing air supplied from the air supply source to the pressurization object device is lower than a temperature in the pressurization object device, at startup.
